(19) United States
(12) Patent Application Publication
(10) Pub. No.: US 2013/0189413 A1
(43) Pub. Date: Jul. 25, 2013

(54) Cantaloupe Peeler

(71) Applicant: John Strelnieks, Indianapolis, IN (US)

(72) Inventor: John Strelnieks, Indianapolis, IN (US)

(21) Appl. No.: 13/745,915

(22) Filed: Jan. 21, 2013

Related U.S. Application Data
(60) Provisional application No. 61/632,303, filed on Jan. 23, 2012.

(51) Int. Cl. A23N 7/00

(52) U.S. Cl. CPC A23N 7/00
USPC 426/482; 99/588; 99/590

(57) ABSTRACT

The present invention relates to a hand-held melon peeler for peeling the rind from melons such as cantaloupe, and to methods of use thereof.

This application claims priority from U.S. Provisional Patent Application Ser. No. 61/632,303 filed Jan. 23, 2012, the entire contents of which is hereby incorporated by reference.

### FIELD OF THE INVENTION

The present invention relates generally to a hand-held device for peeling the rind or skin from a piece of fruit, in particular from cantaloupe fruit.

### BACKGROUND OF THE INVENTION

Prior to consuming certain fruits such as melons, a consumer may find it desirable to remove the skin or rind. For example, when consuming a cantaloupe many individuals cut the whole fruit into slices and then cut the flesh from the rind of each slice prior to consumption. Such preparation steps may be accomplished by use of a knife to slice the fruit away from the rind. However, when trimming with a knife excessive loss of edible fruit may occur, and there can be considerable risk of cuts to a hand or finger during preparation.

Various hand-held devices are available for peeling fruit. For example, apple peelers are known for removing the skin from an apple. A typical fruit peeling device of this type generally includes a handle and two cutting edge members, for example, blades that run parallel with each other and which engage the fruit at a certain depth resulting in peeling away the rind or skin from the fruit as a user rotates the fruit over the device.

Certain fruits such as cantaloupe have a very tough outer peel or rind that can be difficult to cut through. It is therefore desirable to have an easy-to-use hand-held device to remove the rind from cantaloupe prior to consumption.

Various attempts have been made to provide devices for peeling fruit including cantaloupe. For example, US Patent Application US 2011/0034359 discloses a melon peeler system comprising a concave base, a horizontal cutting blade, fasteners, and vertical supports.

U.S. Pat. No. 6,898,857 discloses a hand-held tool for peeling and pitting a fruit such as a mango comprising a spoon-shaped bowl and handle.

U.S. Pat. No. 6,116,155 discloses a mechanical melon peeler comprising a curved peeling blade, a drive gear wheel, and an idler gear wheel which rotate during use to remove the skin from a piece of fruit.

U.S. Pat. No. 6,125,744 discloses a multi-component fruit peeling machine including lower and upper holding assemblies, a frame, an air cylinder, and a carriage assembly coupled to the frame.

U.S. Pat. No. 5,644,490 discloses a melon peeler apparatus comprising a melon slice input channel and drive assembly which cooperate to guide a piece of fruit toward a cutting assembly which includes upper and lower blades to remove the rind.

U.S. Pat. No. 4,920,645 discloses a hand-held fruit or vegetable peeler comprising a handle, a cutting blade, and two support bars parallel to the blade. The blade and at least one support bar are retractable into the handle, thereby releasing any peel that may have wedged between the blade and support bars during use.

U.S. Pat. No. 4,683,655 discloses a hand-held device for peeling citrus fruit. The device comprises a knife with a curved bottom cutting edge.

This prior art is representative of fruit and/or vegetable peeling devices. None of the above references, taken alone or in combination, is seen to describe the present invention as claimed.

Thus, a need remains for a safe, easy-to-use fruit peeler, in particular a hand-held device for peeling cantaloupe.

### SUMMARY OF THE INVENTION

This summary is provided merely to introduce certain concepts and is not intended to identify any key or essential features of the claimed subject matter.

Certain variations of the invention provide an improved device for peeling melons such as cantaloupe comprising a cutting member and a frame.

Accordingly, it is an object of the present invention to provide a safe, efficient, and easy-to-use, hand-held device for removing the rind from melons such as cantaloupe.

### BRIEF DESCRIPTION OF THE DRAWINGS

FIG. 1a provides a front and back view of an embodiment of the peeling device of the invention.

FIG. 1b is a side view of the embodiment shown in FIG. 1a.

FIG. 1c provides a cross-sectional view of a section of the embodiment depicted in FIGS. 1a and 1b.

FIG. 2 provides a schematic view of use of a device of the invention to remove the rind from a piece of cantaloupe.

### DESCRIPTION OF THE SELECTED EMBODIMENTS

A device of the invention comprises a cutting member mounted in a frame. In one embodiment, the frame has any shape that provides comfort and ease-of-use when gripped in hand by a user. The device includes a member or portion that is gripped in hand during use, and a member or portion that contacts a cutting surface during use to remove a rind from a piece of melon. In one aspect, the cutting surface contact member comprises an end, or ends, that contact a cutting surface when the device is used to remove the rind from a melon, for example, a piece of cantaloupe. The frame of the device provides support for the cutting member. The frame includes an opening through which the fruit can pass during removal of a rind. The cutting member is mounted to provide a cutting edge, preferably near the cutting surface contact member. The cutting member may be made from any material that is capable of cutting through fruit including but not limited to metal, plastic, and fabric, including any type of blade, string, or wire. In a preferred embodiment, the cutting member comprises a piece of wire that is mounted under tension to the frame.

For the purpose of promoting an understanding of the principles of the invention, reference will now be made to certain aspects of the embodiments of the invention as illustrated in the drawings and disclosure herein. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. It is also to be understood that any reference to “left” or “right” or “front” or “back” or such other relative terms of orientation are generally for descriptive purposes only, and are not to be taken as exclusive or literal unless otherwise indicated or required by the context. One embodiment of the invention is shown in detail, although it will be apparent to those skilled in the relevant art that some features that are not relevant to the present invention may not be shown for the sake of clarity.

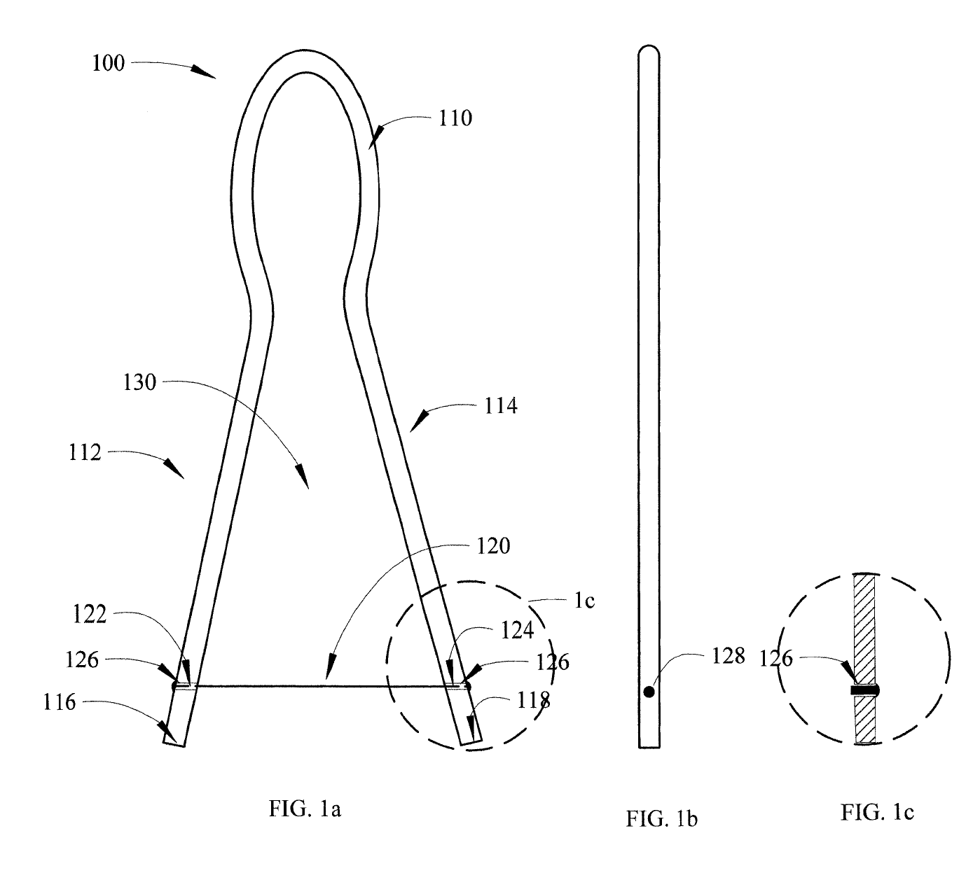

FIGS. 1a-1b illustrate one embodiment of a device of the invention having a hairpin loop or V-shaped frame 100. As depicted in FIG. 1a, the V-shaped embodiment of the device 100 includes a loop-shaped member 110 which is gripped in hand during use, a left member arm 112 and a right member arm 114 which extend away from the loop-shaped member 110. The left member arm 112 and right member arm 114 are flanged outwardly relative to a longitudinal axis bisecting said member arms to create an angle of from about 15° to about 45° between said arm members; preferably from about 20° to about 25°; most preferably about 23°. The arm members define an open portion 130 through which a piece of fruit is passed during use of the device.

The left member arm 112 and right member arm 114 terminate in a left end member 116 and a right end member 118. The left end member 116 and right end member 118 would generally rest on a suitable cutting surface such as a counter top or table during use of the device to guide and support the device during the cutting process. The left end member 116 and right end member 118 can also be used to facilitate rotation of the device during use in an upward or downward direction relative to the cutting surface to adjust the closeness of the cut to the rind. When equipped with a cutting member, as explained further below, the shape of the device and the material from which it is made may help create and maintain a level of tension in the cutting member to assist in peeling a piece of fruit.

In a preferred embodiment, the device 100 includes a wire cutting member 120 for cutting fruit from the rind. The wire cutting member 120 runs across the device 100 between said left member 112 and right member 114. The wire cutting member 120 includes a left end 122 and a right end 124, such that the ends are mounted by any suitable means to the device 100 to maintain the wire cutting member under tension. The wire cutting member 120 can be attached to the device in any manner that provides tension on the cutting member 120. In one embodiment, as shown in FIGS la and lb, the wire cutting member 120 is attached to the device 100 by passing through channels 126 through the left arm 112 and right arm 114 members, and by being held in place by any suitable stop or fastening means 128.

Generally, the wire cutting member 120 is mounted on the device 100 away from the handle end, i.e. loop-shaped member 110, and near the left end 116 and right end 118 members. The wire cutting member 120 is generally mounted on the device 100 a distance “d” from the end members 116 and 118 respectively. In a preferred embodiment, the distance “d” is from about 0.5 inches to about 1 inch; alternatively about 0.75 inches. Generally, the mounting distance d of the wire member 120 away from each of said end members will be the same, or about the same. However, in some embodiments, the mounting distance d from each end could differ by any extent within this approximate size range, for example, where other than straight cuts of fruit are desired. For example, one end of a wire cutting member could be mounted at a distance d₁ of about 0.5 inches from an end member, while the other end of the wire cutting member is mounted a distance d₂ of about 1 inch from said other end member.

A wire cutting member may be made from any suitable material that is capable of maintaining shape and tension such as wire made from any suitable material including but not limited to metal, steel, plastic or another appropriate synthetic material that can be fabricated in appropriately sized wire. Generally, a wire cutting member would have a diameter or gauge in a range of from about 0.1 mm to about 1 mm; preferably about 0.5 mm, and provide from about 2 inches to about 4 inches in cutting length when mounted to the device. A wire cutting member is mounted to a device of the invention in any fashion that results in the cutting member being under enough tension so that a cut to the fruit can easily be made, for example, about the tension more or less on a typical stringed instrument such as between about 5 pounds to about 20 pounds tension depending on wire gauge and material. For example, a wire member may be mounted by fixing the ends of the wire to the ends of the device such that the wire provides a cutting edge that is sufficiently taught to cut through a slice of melon. A cutting wire member may be mounted to the device by any suitable means known to the skilled artisan including, for example, welding, soldering, pinching, looping, gluing, etc. In the embodiment depicted in FIGS. 1a to 1c, the wire passes through a channel 126 in each arm member and is held in place by means of stop knobs 128 or heads at each end of the wire. In some embodiments, the frame of the device and its shape may contribute to the tension on the cutting wire. For example, in the embodiment of FIGS. 1a to 1c, the hairpin loop structure provides a user with some flex when in hand, and when in the fully released position additional tension may be applied to the cutting wire.

As mentioned, the device, or more particularly, the frame of the device according to the invention can have any desired shape including, for example, square, rectangular, oval, triangular, hairpin loop, circular, semi-circular, horseshoe, etc. The frame provides support for the cutting member, such that the cutting member is maintained under sufficient tension to facilitate cutting through the fruit. In some embodiments, the shape of the frame member, or the material from which it is constructed, or both contribute to maintenance of sufficient tension in the cutting wire. The frame member has a cutting end at which is attached the cutting member, and a handle end that facilitates gripping by a user during use to cut fruit. As depicted in FIG. 1a, the handle end comprises any shape that provides comfort in hand during use, for example, circular, oval, triangular, square, rectangular, polygonal, hairpin, etc.

The frame can be open or closed. In an open-frame, as exemplified in FIGS. 1a and 1b, the device includes an open end, defined by the two arms, that houses or accommodates the cutting wire. In an alternative embodiment, the frame member is closed, that is the frame is continuous, without arm members having terminal ends.

A device of the invention can be fabricated by any suitable method or technique known to the skilled artisan, and can be made from any of various materials, preferably materials that are hard or rigid after formation into a shape. For example, the frame can be made of any suitable material that is sturdy enough to maintain some tension on a cutting wire, and withstand the minimal forces encountered during use in cutting a piece of fruit. Suitable but non-exclusive materials for fabricating the frame member include various metals including steel and aluminum, wood, and synthetic or semi-synthetic plastics or thermoplastic materials including but not limited to polystyrene, PVC, nylon, polycarbonate, and acrylic that can be clear, colored, or opaque.

### Use of Peeler

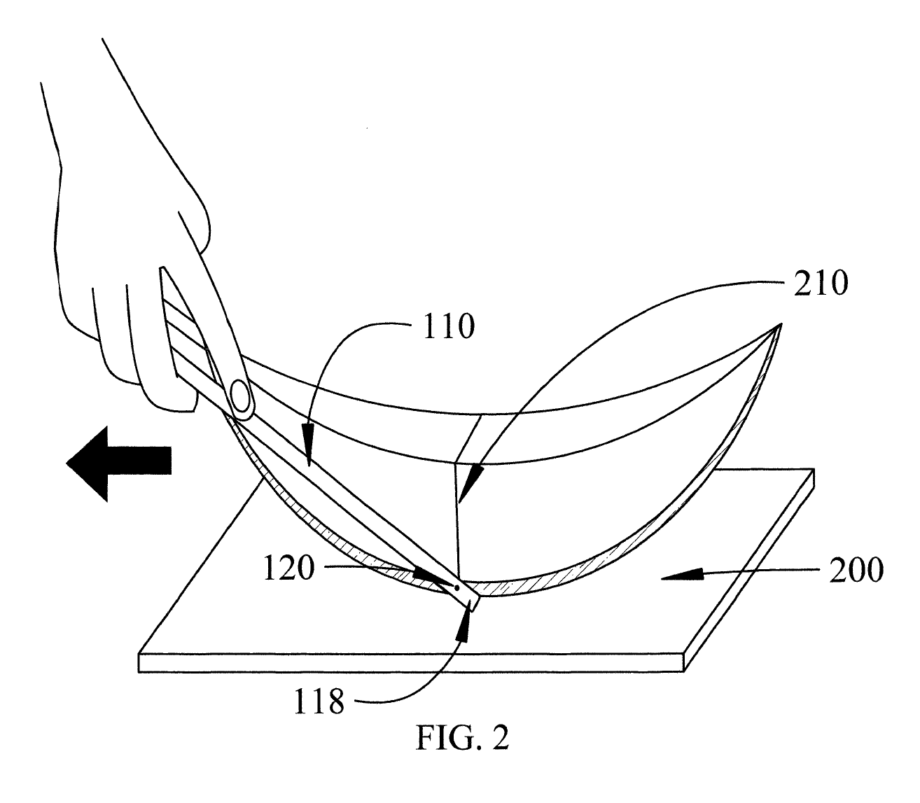

In another aspect, the present invention relates to a method for removing a rind or peel from a melon such as a cantaloupe by using a device of the invention. With reference now to FIG. 2, use of a peeler of the invention, as depicted in FIG. 1a will be described. A user would cut the ends from a melon such as a cantaloupe using a knife, and then halve the fruit lengthwise. After removing the seeds, each half could then be cut in half again to produce quarter sections if desired. Additional sections could be taken if desired to produce eighth or twelfth sections. While supporting a section of fruit to be peeled on a cutting surface 200, a device of the invention 110 is positioned at or near the center of the section of fruit to peeled, and the cutting wire forced in a downward direction until the left end 116 and right end 118 members of the device contact the cutting surface 200 to make an initial cut 210. Then, the user pulls the device away from the initial cut toward one of the ends of the fruit section (as depicted by arrow), while holding the piece of fruit in place, thereby removing roughly a half of the fruit flesh from the rind. Thereafter, the device is repositioned and pulled in the opposite direction to remove the remaining portion of fruit flesh, while the rind is held in place.

While the invention has been illustrated and described in detail in the drawings and foregoing description, the same is to be considered as illustrative and not restrictive in character, it being understood that only preferred embodiments have been shown and described. All changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

What is claimed is:

1. A hand-held melon peeler for removing a rind from a melon comprising:
a. a frame member having a gripping end and a cutting end, said frame comprising an opening through which a slice of melon is passed during removal of said rind;
b. a cutting wire wherein said wire is mounted to said frame member.

2. A peeler as in claim 1 wherein said gripping end of said frame member has a shape selected from hairpin loop, square, rectangular, triangular, circular, polygonal, and oval.

3. A peeler as in claim 2 wherein the cutting end comprises a left arm and right arm.

4. A peeler as in claim 3 wherein each of said left arm and right arm terminate in an arm end for contacting a cutting surface.

5. A peeler as in claim 4 wherein said cutting wire is mounted to said cutting end between said left arm and right arm.

6. A peeler as in claim 5 wherein said cutting wire is mounted a distance of less than or about 1 inch from each of said arm ends.

7. A peeler as in claim 6 wherein said cutting wire has a diameter of from about 0.1 mm to about 1 mm.

8. A peeler as in claim 7 wherein said gripping end has a hairpin loop, square, or rectangular shape.

9. A peeler as in claim 8 wherein said gripping end has a hairpin loop shape.

10. A peeler as in claim 9 wherein said left arm and right arm are flanged outwardly to create an angle between said arms of about 20° to about 25°.

11. A method for removing the rind from a slice of melon comprising the steps of:
a. slicing a melon to produce a plurality of slices, and
b. removing the rind from a slice of melon produced in step a using a device comprising a frame member having a gripping end and a cutting end, said frame comprising an opening through which the slice of melon is passed during removal of said rind; and a cutting wire wherein said wire is mounted to said frame member.

12. A method as in claim 11 wherein the cutting end comprises a left arm and right arm.

13. A method as in claim 12 wherein the cutting wire is mounted to said cutting end between said left and right arm.

14. A method as in claim 13 wherein said left and right arm are flanged outwardly to create an angle between said arms of about 20° to about 25°.

15. A method as in claim 14 wherein said gripping end has a hairpin loop shape.
